(19) United States
(12) Patent Application Publication
(10) Pub. No.: US 2008/0142684 A1
(43) Pub. Date: Jun. 19, 2008

(54) Opto-Electronic Oscillator Clock With Optical Distribution Network

(76) Inventor: Eric R. Ehlers, Sant Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/613,135

(22) Filed: Dec. 19, 2006

(51) Int. Cl. G01J 1/44

(52) U.S. Cl. 250/206

(57) ABSTRACT

Clock circuitry, for an electronic system including a component requiring a clock signal, comprises an opto-electronic oscillator for producing an optical clock signal at an optical clock output; and a feedback loop coupling the optical clock output back to the opto-electronic oscillator.

### BACKGROUND OF THE INVENTION

Many types of digital circuits and systems, such as synchronous circuits and systems, require a clock for operation. Certain analog circuits and systems also require a clock or timing pulse, such as mixers and sampler circuits used in network analyzers and communications systems.

Within a stand-alone integrated circuit, a single oscillator is typically used for the clock. The clock signal it produces is then routed to other parts of the chip. For multi-chip operation, a common clock is often required. In such a case, the clock must be routed to separate integrated circuits, which may be positioned a large enough distance from each other that rise-time degradation due to interconnects and lossy transmission lines may degrade high-speed clock synchronization. Other problems commonly associated with electrical distribution of clock signals include electromagnetic interference, cross-talk, and signal loss.

### SUMMARY OF THE INVENTION

Clock circuitry, for an electronic system including a component requiring a clock signal, comprises an opto-electronic oscillator for producing an optical clock signal at an optical clock output; and a feedback loop coupling the optical clock output back to the opto-electronic oscillator.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a schematic diagram of a clock generation and distribution system embodying the invention.

### DETAILED DESCRIPTION

A typical clock circuit includes an electrical oscillator (such as a VCO that is phase-locked to a stable quartz crystal oscillator). Such a circuit produces an electrical clock signal which is routed to other digital or analog circuits that require a clock signal.

It is desirable to minimize skew and jitter in the clock signal. While an electrical oscillator followed by optical distribution is an adequate solution, it has the disadvantage of requiring an additional optical modulator or E/O converter to generate the required optically modulated signal.

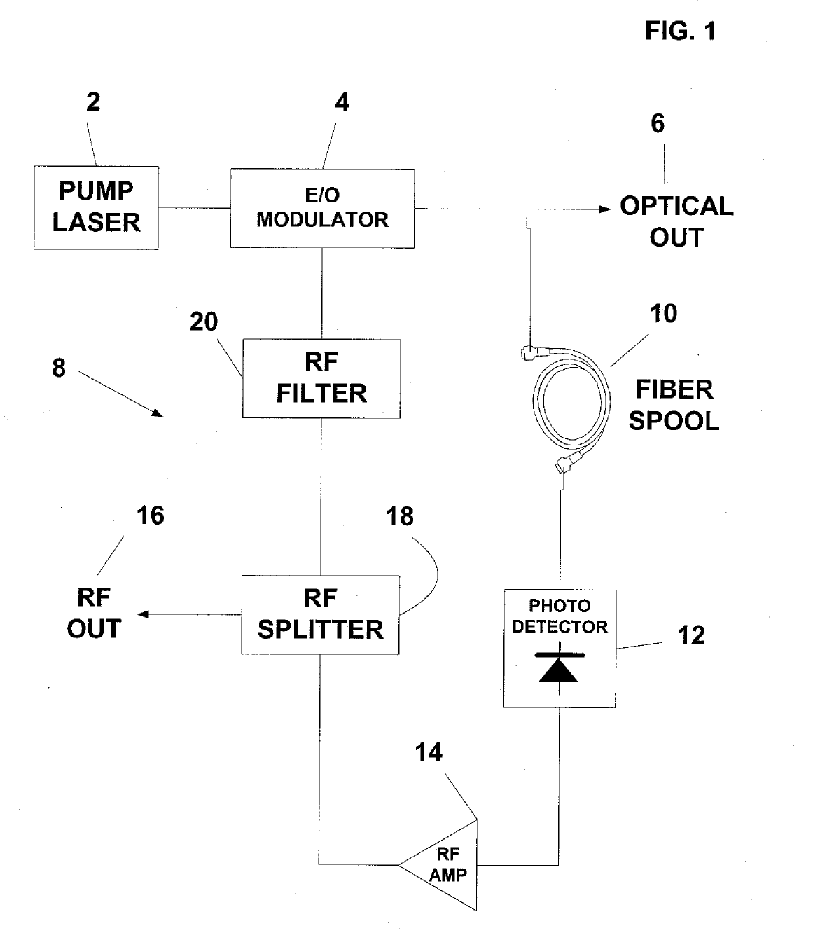

FIG. 1 is a schematic diagram of clock generation and distribution circuitry, embodying the invention, for use in an overall system that requires a clock signal such as an RF clock. In the illustrated embodiment, the system is made up of circuitry including an opto-electrical oscillator having a feedback loop.

The opto-electrical oscillator produces an optical clock output which may then be routed optically to other parts of the system which require the clock. The optical clock signal may then be converted to an electrical signal, for use by the electrical circuitry there.

The feedback loop may include conversion from the optical to the electrical domain, if it is desired to have an electronic clock signal at the location of the clock circuitry. Alternatively, the feedback loop may be entirely optical, employing an optical splitter, fiber splitter, etc.

A light source produces an optical signal. This is shown in FIG. 1 as a pump laser 2, and may be a monochromatic coherent or other source of electromagnetic radiation within or outside the optical spectrum. For convenience but without limitation, “light”, “light source”, etc., will be referred to, synonymously with the pump laser 2, in the discussion which follows. Also, “light” will be used to refer without limitation to the optical signal, electromagnetic radiation, etc., produced by the pump laser 2.

The light source 2 provides an optical signal, such as the monochromatic coherent light just mentioned, to an electrical/optical modulator 4, which modulates the light from the pump laser 2 based on an electrical modulation signal to be discussed below. The result is an optical clock output 6.

The optical clock output 6 is employed in a feedback loop, generally shown as 8.

The optical clock output 6 is directed along a light path, which is shown as a fiber spool 10, but alternatively could be any other light transmission medium, including an optical resonator, free space, etc. A photo detector 12 receives the light and produces an electrical signal responsive to the optical clock output 6. This electrical signal is directed to an RF amplifier 14 or other suitable circuitry. The amplification facilitates a high Q feedback signal.

The output of the RF amplifier 14 is an electrical RF output of the clock generation circuitry of FIG. 1. It is also further used as part of the feedback loop 8. Thus, the electrical RF output 16 is provided by an RF splitter 18. The RF output is filtered by an RF filter 20 to remove undesired signals, such as oscillation modes, that are in the feedback path. The filtered RF signal then is provided as the above-mentioned electrical modulation signal to the electrical/optical modulator 4.

Thus, clock stability is facilitated by using the electrical output signal as feedback to produce the optical clock output 6. Since a modulated optical signal is inherent in the oscillator itself, no additional optical modulator or electrical-to-optical converter is required to operate an optical clock distribution network.

Employing an opto-electronic oscillator to generate the clock produces a very stable clock, since it has very low phase noise and edge jitter. Part of the feedback path 8 uses a modulated optical signal which is routed either in free space or in optical transmission fiber. With the insertion of an optical splitter or coupler (not shown) to split out the optical output 6, the modulated optical signal is easily obtained and can then be distributed by optical fiber or optical waveguide to circuits or systems requiring a common stable clock signal.

The optically modulated clock signal is distributed optically through the system, to components requiring clock signals (“clock destinations”). In general, such clock destinations may be at locations remote from the location of the above-described clock circuitry (“clock source location”), such as on separate PC boards coupled by cables, backplanes, etc., or in separate pieces of equipment coupled together by means of cables, communication links, etc.

At those clock destinations, suitable optical-to-electrical converters (not shown), such as additional photo detectors similar to the photo detector 12, are provided to convert the optical clock back to an electrical clock signal for use by the components located at the clock destinations. Thus the stability needed for a clock is maintained, and the optical modulated signal needed for optical clock distribution is provided without the need for additional optical modulators or E/O converters at the clock destinations.

The opto-electronic oscillator combined with an optical distribution system has improved jitter and skew compared to a conventional electrical clock and electrical distribution network. This is due to a very stable oscillator with a distribution system that minimizes electromagnetic interference, signal line cross-talk, signal loss and rise-time degradation from interconnect reflections and line losses.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. Clock circuitry for an electronic system including a component at a first location and requiring a clock signal, the clock circuitry comprising:
an optical clock generator at a second location remote from the first location and having an optical clock output; and
an optical clock distribution network, for coupling the optical clock output to the component.

2. Clock circuitry as recited in claim 1, the optical clock generator comprising:
an opto-electronic oscillator for producing an optical clock signal at an optical clock output; and
a feedback loop coupling the optical clock output back to the opto-electronic oscillator.

3. Clock circuitry as recited in claim 2, wherein the opto-electronic oscillator includes an electrical/optical modulator, having an optical input, an optical output, and an electronic feedback input.

4. Clock circuitry as recited in claim 3, wherein the opto-electronic oscillator further includes a light source coupled to the optical input of the electrical/optical modulator.

5. Clock circuitry as recited in claim 2, wherein the feedback loop includes:
an optical-to-electronic converter coupled to the optical clock output; and
an electronic clock output coupled to the optical-to-electronic converter.

6. Clock circuitry as recited in claim 5, wherein the optical-to-electrical converter includes a photo detector.

7. Clock circuitry as recited in claim 5, wherein the feedback loop further includes:
an amplifier;
a splitter; and
a filter.

8. Clock circuitry as recited in claim 1, wherein the optical clock distribution network includes:
an optical conduit coupled to the optical clock output, for conveying the optical clock signal to the component requiring the clock signal;
wherein the component requiring the clock signal includes an optical-to-electronic converter, coupled to receive the optical clock signal.

9. A method for generating and distributing a clock signal through a system having clock destinations with components that require clock signals, the method comprising:
generating an optical clock signal;
producing an electronic clock signal from the optical clock signal;
wherein the generating includes employing the electronic clock signal as feedback;
distributing the optical clock signal to clock destinations; and
converting the optical clock signal to an electronic clock signal at the clock destinations.

10. A method as recited in claim 9, wherein the generating includes modulating an optical signal using the feedback.

11. A method as recited in claim 9, wherein the employing as feedback includes:
amplifying the electronic clock signal;
extracting an electronic clock output signal from the amplified electronic clock signal; and
filtering the electronic clock signal.
